(19) United States
(12) Patent Application Publication
(10) Pub. No.: US 2012/0113480 A1
(43) Pub. Date: May 10, 2012

(54) FLAT DISPLAY DEVICE, DISPLAY CONTROL METHOD, AND NON-TRANSITORY COMPUTER-READABLE RECORDING MEDIUM ENCODED WITH DISPLAY CONTROL PROGRAM

(75) Inventors: Takatoshi MOCHIZUKI, Kobe-shi (JP); Masato FUJII, Nagaokakyo-shi (JP)

(73) Assignee: KONICA MINOLTA BUSINESS TECHNOLOGIES, INC., Chiyoda-ku (JP)

(21) Appl. No.: 13/275,667

(22) Filed: Oct. 18, 2011

(30) Foreign Application Priority Data
Nov. 10, 2010 (JP) 2010-252166

(51) Int. Cl. H04N 1/40

(52) U.S. Cl. 358/449

(57) ABSTRACT

A flat display device that can be placed on an image reading apparatus includes: a display surface to display an image; a light detection portion provided on the display surface to detect light; a read region detection portion to, if scanning light emitted by the image reading apparatus is detected by the light detection portion, determine a read region in the display surface based on the detected scanning light; and a display control portion to display an image in the determined read region in the display surface.

This application is based on Japanese Patent Application No. 2010-252166 filed with Japan Patent Office on Nov. 10, 2010, the entire content of which is hereby incorporated by reference.

### BACKGROUND OF THE INVENTION

1. Field of the Invention

The present invention relates to a flat display device, a display control method, and a non-transitory computer-readable recording medium encoded with a display control program, and more particularly to a flat display device displaying an image that can be read by an image reading apparatus, a display control method executed in the flat display device, and a non-transitory computer-readable recording medium encoded with a display control program.

2. Description of the Related Art

Electronic paper displaying images as electronic data has recently become popular. When electronic data includes a plurality of pages, electronic paper can display images of the plurality of pages one by one by switching the display pages. On the other hand, it is sometimes desired that images as electronic data are formed and stored on recording mediums such as paper. Japanese Patent Laid-Open No. 2006-323198 discloses a display device which detects light scan at a prescribed intensity by a copier and switches display images according to the detection result.

However, the conventional display device has a problem in that when a display surface of the display device is larger than a read surface of a copier, the copier cannot read the entire image displayed on the display surface. Furthermore, electronic paper is foldable, and when the display device is placed in the folded state on the read surface of the copier, the copier can read the image displayed on only half the display surface.

### SUMMARY OF THE INVENTION

According to an aspect of the present invention, a flat display device that can be placed on an image reading apparatus includes: a display surface to display an image; a light detection portion provided on the display surface to detect light; a read region detection portion to, if scanning light emitted by the image reading apparatus is detected by the light detection portion, determine a read region in the display surface based on the detected scanning light; and a display control portion to display an image in the determined read region in the display surface.

According to another aspect of the present invention, a flat display device that can be placed on an image reading apparatus includes a display surface including a first display surface and a second display surface to display an image. The display surface can change its shape into a same-direction shape in which the first display surface and the second display surface face in a same direction and into an opposite-direction shape in which the first display surface and the second display surface face in opposite directions. The flat display device further includes: a shape detection portion to detect a shape of the display surface; a light scanning detection portion to detect scanning light emitted by the image reading apparatus; and a display control portion to display an image on one of the first display surface and the second display surface from which the scanning light is detected, when the scanning light is detected in a state in which the opposite-direction shape is detected by the shape detection portion.

According to a further aspect of the present invention, a display control method is executed in a flat display device that can be placed on an image reading apparatus. The flat display device includes a display surface to display an image and a light detection portion provided on the display surface to detect light. The display control method includes the steps of: if scanning light emitted by the image reading apparatus is detected by the light detection portion, determining a read region in the display surface based on the detected scanning light; and displaying an image in the determined read region in the display surface.

According to a still further aspect of the present invention, a non-transitory computer-readable recording medium is encoded with a display control program performed by a computer being configured to control a flat display device that can be placed on an image reading apparatus. The flat display device includes a display surface to display an image and a light detection portion provided on the display surface to detect light. The display control program causes the computer to execute processing including the steps of: if scanning light emitted by the image reading apparatus is detected by the light detection portion, determining a read region in the display surface based on the detected scanning light; and displaying an image in the determined read region in the display surface.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a plan view of electronic paper in a first embodiment of the present invention.

FIG. 2 is a block diagram showing an exemplary hardware configuration of the electronic paper in the first embodiment.

FIG. 3 is a block diagram showing an example of functions of a CPU of the electronic paper in the first embodiment.

FIG. 4 is a diagram showing an example of a setting screen.

FIG. 5 is a flowchart showing an exemplary flow of a display control process in the first embodiment.

FIG. 6 is a plan view of electronic paper in a second embodiment of the present invention.

FIG. 7 is a block diagram showing an exemplary hardware configuration of the electronic paper in the second embodiment.

FIG. 8 is a functional block diagram showing an example of functions of a CPU of the electronic paper in the second embodiment.

FIG. 9 is a flowchart showing an exemplary flow of a display control process in the second embodiment.

### DESCRIPTION OF THE PREFERRED EMBODIMENTS

The preferred embodiments of the present invention will be described below in conjunction with the drawings. In the following description, the same parts are denoted by the same reference characters. Their names and functions are also the same. Thus, a detailed description thereof will not be repeated.

### First Embodiment

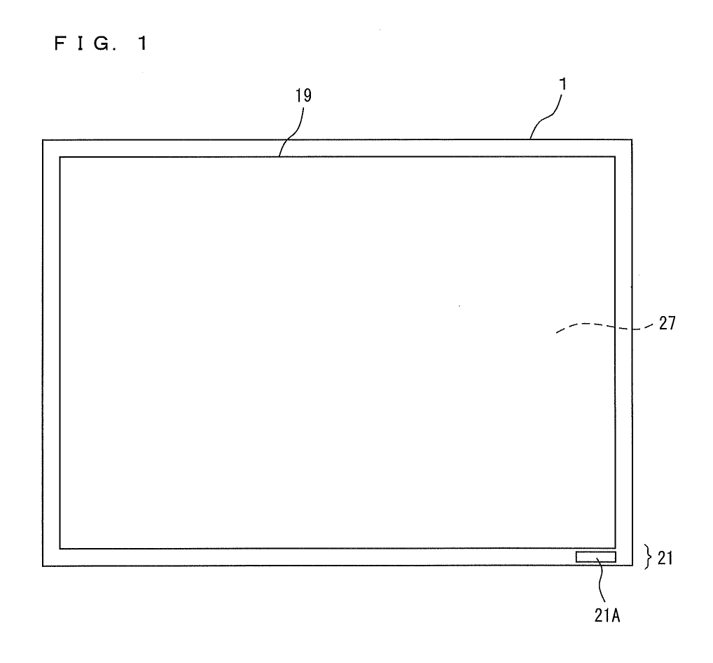

FIG. 1 is a plan view of electronic paper in a first embodiment of the present invention. Referring to FIG. 1, electronic paper 1 includes a display portion 19 on a top surface thereof and an operation portion 21 including a power key 21A. A flat light sensor 27 is provided in the same region as display portion 19.

Display portion 19 is configured such that a plurality of pixels in a two-dimensional array are formed on a resin substrate, and a TFT (Thin Film Transistor) element is arranged for each pixel. Flat light sensor 27 is configured such that a photo-sensor, for example, of amorphous Si is provided for each pixel. Display portion 19 and flat light sensor 27 are made of flexible materials so that electronic paper 1 can be folded. Thus, a display surface of display portion 19 on which an image is displayed can be divided into a first display surface and a second display surface when electronic paper 1 is folded. Electronic paper 1 can change its shape into a same-direction shape in which the first display surface and the second display surface of display portion 19 face in the same direction, and into an opposite-direction shape in which the first display surface and the second display surface face in opposite directions.

A flat display device (including a sheet-like display) including a liquid crystal display (LCD), an organic ELD (Electroluminescence Display), or the like may be used in place of electronic paper 1. In this case, a flat display device that can change its shape into the same-direction shape and the opposite-direction shape can be configured such that two LCDs or organic ELDs are arranged side by side to serve as the first display surface and the second display surface. The two LCDs or organic ELDs preferably have the same size. The display surface of display portion 19 is A3 size. FIG. 1 shows electronic paper 1 with the longitudinal direction arranged horizontally. In the following description, the directions of the display surface are defined with reference to electronic paper 1. In the following, “the upward direction of the display surface” refers to the direction from the bottom toward the top in FIG. 1 in electronic paper 1 shown in FIG. 1, “the downward direction of the display surface” refers to the direction from the top toward the bottom in FIG. 1 in electronic paper 1 shown in FIG. 1, “the leftward direction of the display surface” refers to the direction from the right toward the left in FIG. 1 in electronic paper 1 shown in FIG. 1, and “the rightward direction of the display surface” refers to the direction from the left toward the right in FIG. 1 in electronic paper 1 shown in FIG. 1.

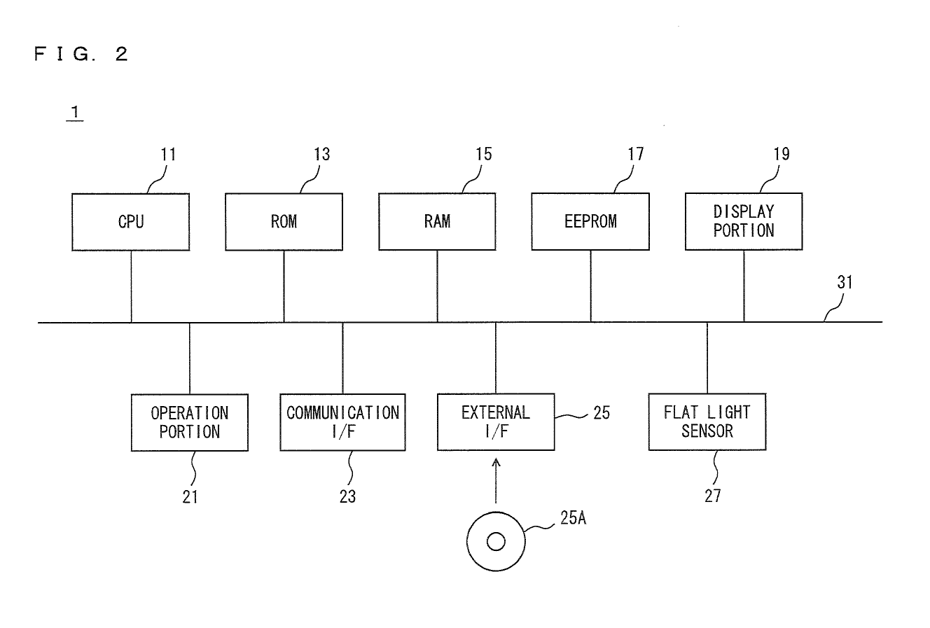

FIG. 2 is a block diagram showing an exemplary hardware configuration of the electronic paper in the first embodiment. Referring to FIG. 2, electronic paper 1 includes a CPU (Central Processing Unit) 11 controlling the entire electronic paper 1, a ROM (Read Only Memory) 13, a RAM (Random Access Memory) 15, an EEPROM (Electronically Erasable and Programmable ROM) 17, display portion 19, operation portion 21 for accepting user's operations, a communication interface (I/F) 23 for connecting electronic paper 1 to a network, an external interface (I/F) 25, and flat light sensor 27, each of which is connected to a bus 31.

Display portion 19 is controlled by CPU 11 to display an image. ROM 13 stores a program executed by CPU 11 or data necessary to execute the program. RAM 15 is used as a work area for CPU 11 to execute a program. EEPROM 17 stores a program or data in a nonvolatile manner.

Flat light sensor 27 detects light for each pixel in the display surface of display portion 19 and outputs a set of the quantity of the detected light and the position of the pixel to CPU 11. When the user points to the display surface of display portion 19, the quantity of light at the position pointed to on the display surface is reduced, whereby CPU 11 detects the position pointed to by the user on the display surface based on the output of flat light sensor 27 and thus uses flat light sensor 27 as a touch panel.

Operation portion 21 includes a plurality of keys including power key 21A. Communication I/F 23 is an interface for connecting electronic paper 1 to an external computer. For example, communication I/F 23 is a communication circuit capable of serial communication or parallel communication. CPU 11 communicates with the connected computer through communication I/F 23 to transmit/receive data. Communication I/F 23 may be an interface for connecting electronic paper 1 to a network such as a local area network. In this case, CPU 11 can communicate with another electronic paper or a computer through communication I/F 23 to transmit/receive data or can communicate with a computer connected to the Internet through a network.

External I/F 25 is an interface for communicating with an external storage device. Here, external I/F 25 performs serial communication with the connected external storage device. When a CD-ROM driver is connected as an external storage device to external I/F 25, CPU 11 can access a CD (Compact Disc)-ROM 25A attached to the CD-ROM driver through external I/F 25. CPU 11 can load a program stored in CD-ROM 25A into RAM 15 for execution.

It is noted that a program executed by CPU 11 is not limited to a program stored in CD-ROM 25A, and CPU 11 may load a program stored in EEPROM 17 into RAM 15 for execution. In this case, another computer connected to a network may overwrite the program stored in EEPROM 17 of electronic paper 1 or additionally write a new program. Electronic paper 1 may download a program from another computer connected to a network and store the program into EEPROM 17. The program referred to herein includes not only a program directly executable by CPU 11 but also a source program, a compressed program, and an encrypted program.

Electronic paper 1 in the present embodiment is placed with the display surface of display portion 19 facing the reading portion of an image reading apparatus such as a copier and is read by the copier in a state in which an image is displayed on the display surface of display portion 19. In this case, during pre-scan which the copier executes at a stage prior to scanning the actual image, flat light sensor 27 detects a region scanned with scanning light by the copier. Since flat light sensor 27 detects the quantity of light for each pixel of display portion 19, the read region detected by flat light sensor 27 can be specified as a region in the display surface of display portion 19. Furthermore, since the scan in the pre-scan executed by a copier or the scan for reading an image is done with light at a prescribed intensity or higher, it can be determined that scan by a copier is done when flat light sensor 27 detects light at a prescribed intensity or higher, and a region from which light at a prescribed intensity or higher is detected can be detected as a read region scanned by a copier.

Here, the display surface of display portion 19 of electronic paper 1 is placed on a copier, by way of example. However, any other image reading apparatus such as a scanner apparatus, a facsimile, or a multifunction apparatus that combines a scanner, facsimile and copier may be used as long as it has the function of reading an image with scanning light.

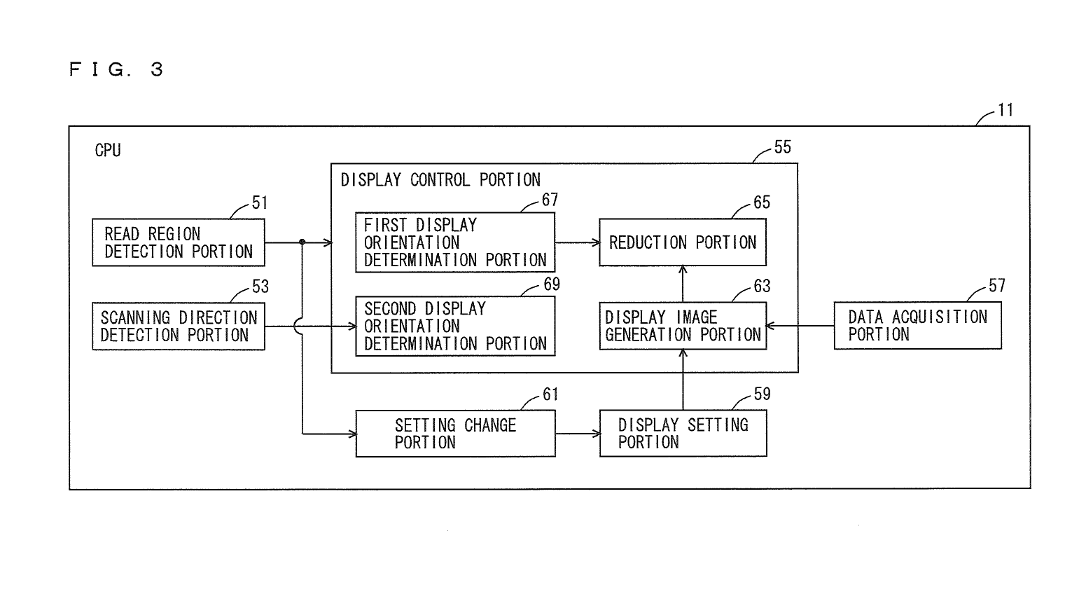

FIG. 3 is a block diagram showing an example of functions of the CPU of the electronic paper in the first embodiment. The functions of CPU 11 shown in FIG. 3 is formed in CPU 11 when CPU 11 executes a display control program stored in ROM 13, EEPROM 17, or CD-ROM 25A.

Referring to FIG. 3, CPU 11 includes a read region detection portion 51 for determining a read region, a scanning direction detection portion 53 for detecting a scanning direction, a display control portion 55 for controlling display of display portion 19, a data acquisition portion 57 for acquiring data to be displayed, a display setting portion 59 for setting a display manner of images of a plurality of pages, and a setting change portion 61 for changing the set display manner.

Read region detection portion 51 monitors output of flat light sensor 27, and when detecting a scan with light at a prescribed intensity, determines a region in the display surface of display portion 19 where the scan with light at a prescribed intensity is detected, as a read region. Read region detection portion 51 outputs the position of the detected read region in the display surface to display control portion 55 and setting change portion 61. The position of the read region in the display surface is represented, for example, by the diagonal coordinate values of the rectangular read region. As long as the read region can be specified, the coordinates of the outline of the read region or the coordinates of the entire read region may be used in place of the diagonal coordinate values.

Scanning direction detection portion 53 monitors output of flat light sensor 27 and, when detecting a scan with light at a prescribed intensity, detects the direction in which the detected scanning light moves relative to the display surface of display portion 19, as the scanning direction. Here, it is assumed that the copier has a line sensor and the copier makes a scan by moving the line sensor in the main scanning direction vertical to the direction (sub-scanning direction) in which the pixels of the line sensor are arranged. Scanning direction detection portion 53 detects the main scanning direction. In the following, the scanning direction refers to the main scanning direction. Scanning direction detection portion 53 outputs the detected scanning direction to display control portion 55. The scanning direction detected by scanning direction detection portion 53 is a relative direction that is determined with reference to the display surface of display portion 19.

Data acquisition portion 57 accepts a user's operation, reads out display data from among data stored in EEPROM 17 in accordance with the accepted operation, and outputs the read display data to display control portion 55.

Display setting portion 59 accepts a user's operation and selects one of a plurality of predetermined layout rules in accordance with the accepted operation. One layout rule is determined based on a paper output direction and a layout manner. The paper output direction is a direction in which a copier on which electronic paper 1 is placed ejects paper having an image formed thereon. The paper output direction is face up when the surface of the output paper having an image formed thereon faces up. The paper output direction is face down when the surface having an image formed thereon faces down.

The layout manner includes three manners: normal layout (normal), 2-in-1, and booklet. The normal layout manner is a layout in which the display image is an image of each of a plurality of pages included in the display data. Therefore, in the case of the normal layout, the number of the display images is equal to the number of pages included in the display data. The normal layout includes a case where the order of the display images is the same as the page number order of a plurality of pages included in the display data (first normal layout) and a case where it is reversed (second normal layout). The order of the images displayed by electronic paper 1 is determined by the paper output direction.

In the case where the layout manner is the normal layout and the paper output direction is face down, the order of the display images is the same as the page order of a plurality of pages included in the display data, that is, the first normal layout. Specifically, the image of the first page of the display data is arranged on the first page of the display image, and the image of the next page of the display data is successively arranged on the second and subsequent pages of the display image.

In the case where the layout manner is the normal layout and the paper output direction is face up, the order of the display images is the reverse of the page order of a plurality of pages included in the display data, that is, the second normal layout. Specifically, the image of the last page of the display data is arranged on the first page of the display image, and the image of the previous page of the display data is successively arranged on the second and subsequent pages of the display image.

In the 2-in-1 layout manner, a display image is formed such that, to the right of the image of an odd page of a plurality of pages that constitute the display data, the image of the next, even page is arranged. Therefore, in the case of the 2-in-1 layout manner, the number of the display images is half the number of the pages that constitute the display data, or half the number plus one. In the case of the 2-in-1 layout manner and where the paper output direction is face down, the image of the first odd page (first page) of the display data is arranged on the left side of the first page of the display image, and the image of the next odd page of the display data is successively arranged on the left side of the second and subsequent pages of the display image. This layout is called the first 2-in-1 layout. In the case of the 2-in-1 layout and where the paper output direction is face up, the image of the last odd page of the display data is arranged on the left side of the first page of the display image, and the image of the previous odd page of the display data is successively arranged on the left side of the second and subsequent pages of the display image. This layout is called the second 2-in-1 layout.

In the booklet layout manner, the images of two pages selected from a plurality of pages that constitute the display data are arranged on the right and left of the display image. In this layout, when plural sheets of paper having images formed thereon are folded down the middle, the images appear in the page order of the display data. Specifically, in the case of the booklet layout manner and where the paper output direction is face down, the display images are such that the image of the (N−n+1)th page is arranged to the right of the image of the n-th page (n is a positive integer) of the display data, in the order from the first page to the next page. This layout is called the first booklet layout. In the case of the booklet layout manner and where the paper output direction is face up, the display images are such that the image of the (N−n+1)th page is arranged to the right of the n-th page (n is a positive integer) of the display data, in the order from the N-th page to the previous page. This layout is called the second booklet layout.

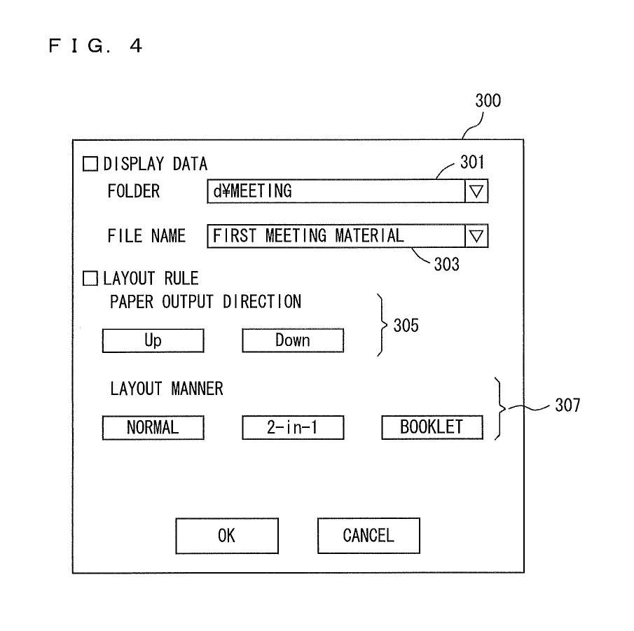

FIG. 4 is a diagram showing an example of a setting screen. Referring to FIG. 4, a setting screen 300 includes an area for designating display data and an area for setting a layout rule. The area for designating display data includes an area 301 for designating a folder and an area 303 for designating a file name. When the user points to the inverted triangle mark on the right end of area 301, a pull-down menu appears to allow a selection of folder names for identifying folders as storage areas of EEPROM 17. The user designates one of the folder names displayed in the pull-down menu to designate the folder having the folder name pointed to, and the folder name is displayed in area 301. When the user points to the inverted triangle mark on the right end of area 303, a pull-down menu appears to allow a selection of file names for identifying files stored in the designated folder in area 301. The user designates one of the file names displayed in the pull-down menu to designate the file having the file name pointed to, and the file name is displayed in area 303.

The area for setting a layout rule includes an area 305 for setting a paper output direction and an area 307 for setting a layout manner. Area 305 for setting a paper output direction includes a button labeled with “Up” and a button labeled with “Down.” When the user points to the button labeled with “Up,” the paper output direction is set to face up, and when the user points to the button labeled with “Down,” the paper output direction is set to face down. Area 307 for setting a layout manner includes a button labeled with “normal,” a button labeled with “2-in-1,” and a button labeled with “booklet.” When the user points to the button labeled with “normal,” the layout manner is set to the normal layout. When the user points to the button labeled with “2-in-1,” the layout manner is set to 2-in-1. When the user points to the button labeled with “booklet,” the layout manner is set to booklet.

Setting screen 300 further includes a button labeled with “OK” and a button labeled with “Cancel.” The user points to the button labeled with “OK” to decide on the display data specified by the folder name and file name set in area 301 for designating a folder and area 303 for designating a file name and to select the layout rule defined by the paper output direction and layout manner set in area 305 for setting a paper output direction and area 307 for setting a layout manner.

Returning to FIG. 3, display setting portion 59 outputs the setting information including the paper output direction and layout manner, that is, the selected layout rule, to display control portion 55.

Setting change portion 61 receives the position of the read region in the display surface from read region detection portion 51. Setting change portion 61 changes the layout manner to “normal layout” when the layout manner is set to “2-in-1” or “booklet” in display setting portion 59 and if the size of the read region is smaller than the size of the display surface. If the settings of the layout manner are changed by setting change portion 61, display setting portion 59 outputs the changed setting information to display control portion 55.

When the layout manner is set to “2-in-1” or “booklet” in which a composite image including images of a plurality of pages arranged side by side is successively displayed, and if the size of the read region is smaller than the size of the display surface, the setting is changed to the layout manner “normal layout” in which an image of one page is successively displayed in the page number order. Therefore, the images of all the pages included in the display data can be read by a copier. In addition, the display image can be displayed in the largest possible size so that the size of the display image generated by display control portion 55 as described later and displayed on display portion 19 is not too small.

Display control portion 55 includes a display image generation portion 63, a reduction portion 65, a first display orientation determination portion 67, and a second display orientation determination portion 69. Display image generation portion 63 receives display data from data acquisition portion 57 and receives the setting information from display setting portion 59. Display image generation portion 63 generates a display image based on page data included in the display data, in accordance with the layout rule defined by the paper output direction and layout manner included in the setting information. The display image may include images of a plurality of pages.

Display image generation portion 63 determines the size and display orientation of the display image such that the display image is displayed on the entire display surface of electronic paper 1, and generates the display image in the determined size. The display orientation is the orientation in which the image orientation that is from the bottom side toward the top side of the image is directed. For example, when the layout manner is set to “normal layout” as the setting information, the size of the display image is set to A3, and the display orientation is determined to be the rightward direction of the display surface. When the layout manner is set to “2-in-1” or “booklet” as the setting information, the size of one display image in which images of two pages are arranged on the right and left is set to A3, and the display orientation is determined to be the upward direction of the display surface. Display image generation portion 63 outputs the generated display image to reduction portion 65. Here, it is assumed that the display image is composed of M pages where M is a positive integer.

First display orientation determination portion 67 receives the position of the read region in the display surface from read region detection portion 51 and determines a first orientation in which an image is displayed in the read region. The first orientation is the orientation in which the display image is displayed in the read region and which is a relative direction determined with reference to the display surface. First display orientation determination portion 67 determines the first orientation based on the aspect ratio of the display surface and the aspect ratio of the read region. The aspect ratio is a ratio of the horizontal direction (right-left direction) to the length of the vertical direction (top-bottom direction) of the image with reference to the orientation of electronic paper 1. A first value is calculated by dividing the aspect ratio of the display surface by the aspect ratio of the read region, and a second value is calculated by multiplying the aspect ratio of the display surface by the aspect ratio of the read region (dividing the aspect ratio of the display surface by the reciprocal of the aspect ratio of the read region). It is then determined that which of the first value and the second value is close to “1.” If the first value is closer to “1” than the second value, the display orientation is determined as the first orientation. If the second value is closer to “1” than the first value, the orientation in which the display orientation is rotated counterclockwise by 90° is determined as the first orientation.

The first orientation for displaying the display image in the read region in the display surface is determined based on the aspect ratio of the read region and the aspect ratio of the display image, so that the display image can be displayed so as to be contained in the largest possible size in the read region. When the display image is landscape, the horizontal direction of the display image is matched with the longitudinal direction of the read region. When the display image is portrait, the vertical direction of the display image is matched with the longitudinal direction of the read region.

Here, the orientation in which the display orientation is rotated clockwise by 90° may be determined as the first orientation. In which direction the display orientation is rotated may be determined beforehand. First display orientation determination portion 67 outputs the determined first orientation to second display orientation determination portion 69 and outputs the first orientation and the position of the read region in the display surface to reduction portion 65.

Second display orientation determination portion 69 receives the scanning direction from scanning direction detection portion 53 and receives the first orientation from first display orientation determination portion 67 to determine the second orientation. The second orientation is the orientation in which the display image is displayed in the read region and which is a relative direction determined with reference to the display surface. The orientation of a document with respect to the scanning direction is fixed depending on a copier. If the first orientation is the same as the orientation of a document fixed by the copier with respect the scanning direction, second display orientation determination portion 69 determines the first orientation as the second orientation. If the first orientation is different from the orientation of a document fixed by the copier with respect, to the scanning direction, second display orientation determination portion 69 determines the orientation opposite to the first orientation as the second orientation.

The orientation of a document that is predetermined by a copier with respect to the scanning direction is specified, and the second orientation is determined such that the display orientation of the display image is the same as the orientation of the document, so that the display image can be displayed to match the direction in which the copier scans a document. As a result, the paper having an image formed thereon which is ejected by the copier can be set in an appropriate orientation. In particular, this is effective in duplex copy in which the copier forms images on both sides of paper.

Reduction portion 65 receives the display image from display image generation portion 63 and receives the first orientation and the position of the read region in the display surface from first display orientation determination portion 67. If the first orientation input from first display orientation determination portion 67 is the leftward direction of the display surface or the rightward direction of the display surface, reduction portion 65 calculates a first potential reduction rate by dividing the length in the horizontal direction of the read region by the length in the horizontal direction of the display surface, calculates a second potential reduction ratio by dividing the length in the vertical direction of the read region by the length in the vertical direction of the display surface, and determines either smaller value as a reduction ratio. If the first orientation input from first display orientation determination portion 67 is the upward direction of the display surface or the downward direction of the display surface, reduction portion 65 calculates a third potential reduction ratio by dividing the length in the vertical direction of the read region by the length in the horizontal direction of the display surface, calculates a fourth potential reduction ratio by dividing the length in the horizontal direction of the read region by the length in the vertical direction of the display surface, and determines either smaller value as a reduction ratio. Reduction portion 65 generates a reduced image in which the display image input from display image generation portion 63 is reduced at the determined reduction ratio. The display orientation of the reduced image is the same as the display orientation of the display image.

The reduction ratio is determined from the size of the read region in the display surface and the size of the display image, so that the display image can be displayed so as to be contained in the read region at the largest possible size and can be reduced to such a size that the display image does not extend off the read region.

Display control portion 55 displays the reduced image generated by reduction portion 65 in the read region of electronic paper 1 such that the image orientation of the reduced image matches the second orientation.

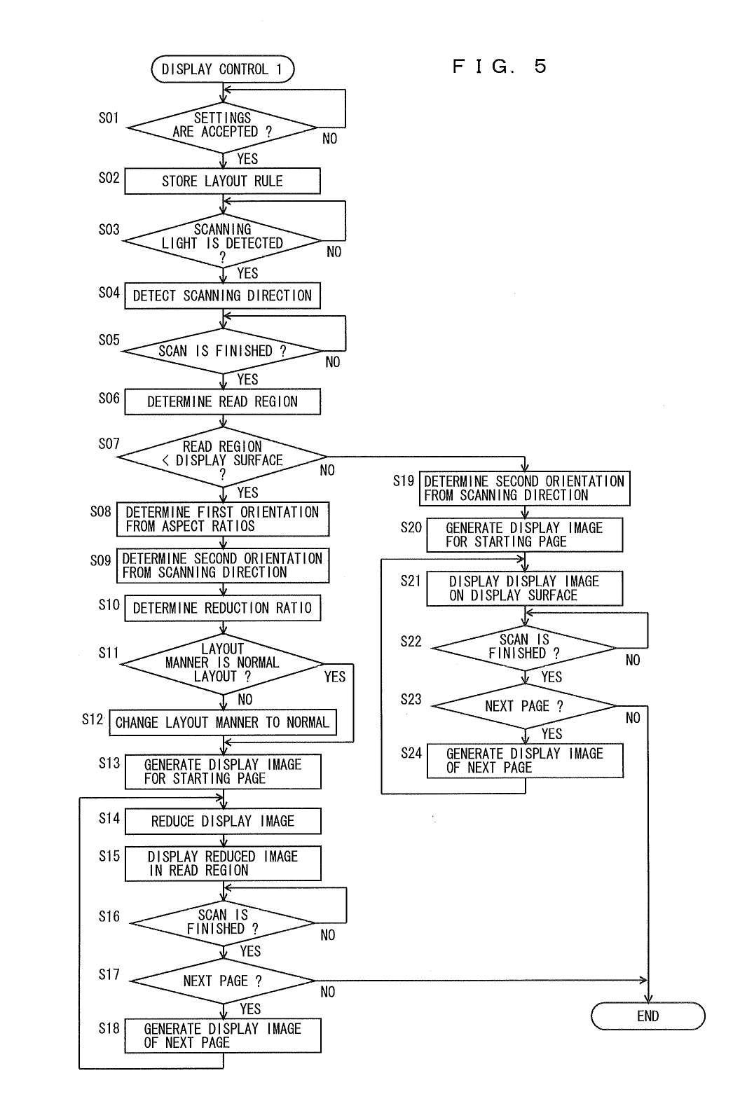

FIG. 5 is a flowchart showing an exemplary flow of a display control process in the first embodiment. The display control process is a process executed by CPU 11 when CPU 11 executes a display control program stored in EEPROM 17. Referring to FIG. 5, CPU 11 determines whether the settings are accepted (step S01). The setting screen shown in FIG. 4 appears on electronic paper 1, and it is determined whether the setting for specifying display data and the setting for specifying a layout rule are accepted. The process waits until the settings are accepted (NO in step S01). If the settings are accepted, the display data is read out, and the process then proceeds to step S02. In step S02, the layout rule accepted in step S01 is temporarily stored in RAM 15.

In step S03, it is determined whether scanning light is detected. Scanning light is detected when flat light sensor 27 detects light at a prescribed intensity. The process waits until scanning light is detected (NO in step S03). If flat light sensor 27 detects light at a prescribed intensity (YES in step S03), it is determined that pre-scan by a copier starts, and the process then proceeds to step S04. In step S04, the scanning direction is detected. As the pixels from which light at a prescribed intensity is detected by flat light sensor 27 move on over time, the direction in which the pixels from which light at a prescribed intensity is detected move on in the display surface is detected as the scanning direction. In the next step S05, it is determined whether the operation is finished. It is determined that the scan by pre-scan is finished when flat light sensor 27 no longer detects light at a prescribed intensity. The process waits until the end of scan is detected (NO in step S05). If the end of scan is detected (YES in step S05), the process proceeds to step S06.

In step S06, the read region is determined. The region from which flat light sensor 27 detects light at a prescribed intensity is determined as the read region. Then, it is determined whether the size of the read region is smaller than the display surface of electronic paper 1 (step S07). If the size of read region is smaller than the size of the display surface of electronic paper 1, the process proceeds to step S08. If not, the process proceeds to step S19.

In step S19, the second orientation is determined from the scanning direction detected in step S04. As the orientation of the document with respect to the scanning direction is fixed depending on a copier, the second orientation in which the image is displayed on electronic paper 1 is determined based on the information obtained from the copier and the scanning direction. Specifically, when the display orientation of the display image is determined as the first orientation, and if the first orientation is the same as the orientation fixed by the copier with respect to the scanning direction depending on the copier, then the first orientation is determined as the second orientation. If the first orientation is different from the orientation fixed by the copier with respect to the scanning direction, the direction opposite to the first orientation is determined as the second orientation. Accordingly, the display image can be displayed such that the image orientation of the display image matches the scanning direction of the copier.

In the next step S20, a display image for the starting page is generated. In this case, a display image for the starting image is generated by arranging images of a plurality of pages included in the display data read out in step S01 according to the layout rule stored in step S02. The generation of display image includes determination of the display orientation in which the image orientation of the display image is directed. The display orientation is the direction in which the image orientation that is from the bottom side toward the top side of the image is directed. Here, when the layout manner is set to “normal layout,” the display orientation is in the rightward direction of the display surface, and when the layout manner is set to “2-in-1” or “booklet,” the display orientation is in the upward direction of the display surface.

Then, the display image is displayed on the display surface of electronic paper 1 such that the image orientation of the display image matches the second orientation determined in step S20 (step S21). In the next step S22, it is determined whether the scan is finished. The process waits until the end of scan is detected (NO in step S22). If the end of scan is detected (YES in step S22), the process proceeds to step S23. The display image appearing on the display surface of electronic paper 1 does not switch until the copier has finished a single scan, so that the time for the copier to read off the display image appearing on electronic paper 1 is secured.

In step S23, it is determined whether there exists a page that has not been displayed as a display image among the pages included in the display data. If such a page exists, the process proceeds to step S24. If not, the process ends. In step S24, a display image of the next page is generated by arranging the image of the next page of images of a plurality of pages included in the display data read out in step S01, according to the layout rule stored in step S02. The process then returns to step S21. In conjunction with the generation of display image, the display orientation of the display image is determined similarly as described in step S21.

On the other hand, in step S08, the first orientation is determined from the respective aspect ratios of the read region determined in step S06 and the display surface. The first orientation is the orientation in which the display image is displayed in the read region and which is a relative direction determined with reference to the display surface. Specifically, a first value is calculated by dividing the aspect ratio of the display surface by the aspect ratio of the read region, and a second value is calculated by multiplying the aspect ratio of the display surface by the aspect ratio of the read region. Then, if the first value is closer to “1” than the second value, the display orientation is determined as the first orientation. If the second value is closer to “1” than the first value, the direction in which the display orientation is rotated counterclockwise by 90° is determined as the first orientation.

In the next step S09, the second orientation is determined from the scanning direction detected in step S04. The second orientation is the orientation in which the display image is displayed in the read region and which is a relative direction determined with reference to the display surface. The orientation of a document with respect of the scanning direction is fixed depending on a copier. In step S09, if the first orientation determined in step S08 is the same as the orientation fixed by the copier with respect the scanning direction, the first orientation is determined as the second orientation. If the first orientation is different from the orientation fixed by the copier with respect the scanning direction, the direction opposite to the first orientation is determined as the second orientation.

In step S10, a reduction ratio is determined. If the first orientation determined in step S08 is in the leftward direction or rightward direction of the display surface, a first potential reduction ratio is calculated by dividing the length in the horizontal direction of the read region by the length in the horizontal direction of the display surface, and a second potential reduction ratio is calculated by dividing the length in the vertical direction of the read region by the length in the vertical direction of the display surface. Then, either smaller value is determined as a reduction ratio. If the first orientation determined in step S08 is in the upward direction or downward direction of the display surface, a third potential reduction ratio is calculated by dividing the length in the vertical direction of the read region by the length in the horizontal direction of the display surface, and a fourth potential reduction ratio is calculated by dividing the length in the horizontal direction of the read region by the length in the vertical direction of the display surface. Then, either smaller value is determined as a reduction ratio.

Then, it is determined whether the layout manner is normal layout (step S11). If the layout manner of the layout rule temporarily stored in RAM 15 in step S02 is not set to normal layout, the process proceeds to step S12. If it is set to normal layout, the process skips step S12 and proceeds to step S13. In step S12, the layout manner is changed to normal layout, and the process then proceeds to step S13.

In step S13, an image for the starting page is generated. If the layout manner is changed to normal layout in step S12, an image for the starting page is generated as a display image by arranging images of a plurality of pages included in the display data read out in step S01, according to the changed layout rule. If the layout manner is not changed to normal layout in step S12, an image for the starting page is generated as a display image by arranging images of a plurality of images included in the display data read out in step S01, according to the layout rule stored in step S02. The display orientation of the display image is determined similarly as described in step S21.

In the next step S14, the display image is reduced at the reduction ratio determined in step S10. The display orientation of the reduced image is the same as the display orientation of the display image. Then, the reduced image which is reduced in step S14 is displayed on the display surface of electronic paper 1 such that the image orientation of the reduced image matches the second orientation determined in step S09 (step S15). In the next step S16, it is determine whether the scan is finished. The process waits until the end of scan is detected (NO in step S16). If the end of scan is detected (YES in step S16), the process proceeds to step S17. The display image appearing on the electronic paper does not switch until the copier has finished a single scan, so that the time for the copier to read off the display image appearing on electronic paper 1 is secured.

In step S17, it is determined whether there exists a page that has not been displayed as a display image among the pages included in the display data. If such a page exists, the process proceeds to step S18. If not, the process ends. In step S18, a display image of the next page is generated in a similar manner as the generation of a display image for the starting page in step S13. The process then returns to step S14. In conjunction with the generation of a display image, the display orientation of the display image is also determined.

As described above, when scanning light emitted by a copier is detected, electronic paper 1 in the first embodiment determines a read region in the display surface based on the detected scanning light and displays a display image in the read region in the display surface. Therefore, an image can be displayed in a region that can be read by the copier. For example, even when the size of the region that can be read by the copier is smaller than the display surface, the copier can read the entire image.

The first orientation in which the display image is displayed in the read region in the display surface is determined based on the aspect ratio of the determined read region and the aspect ratio of the display image. Therefore, the image can be displayed so as to be contained at the largest possible size in the read region.

Furthermore, the scanning direction with respect to the display surface is detected based on the detected scanning light, and the predetermined orientation of a document in a copier is specified based on the scanning direction. The second orientation is then determined such that the display orientation is the same as the orientation of the document. A reduced image is displayed in the read region such that the image orientation of the reduced image is the second orientation. Therefore, the reduced image can be displayed to match the direction in which the copier reads the image. In addition, the paper having an image formed thereon which is ejected by the copier can be oriented in an appropriate direction. This is particularly effective in duplex copy.

The display image is reduced at a reduction ratio determined from the size of the read region in the display surface and the size of the display image, and the reduced image is then displayed in the read region, so that the display image can be displayed so as to be contained at the largest possible size in the read region.

When the setting is such that a composite image including images of a plurality of images arranged side by side is successively displayed, if the size of the read region is smaller than the size of the display surface, the setting is changed such that an image of one page is successively displayed in the page number order. Therefore, the images of all the pages included in the display data can be read by the copier. Furthermore, the display image can be displayed at the largest possible size.

### Second Embodiment

In the following, electronic paper 1A in a second embodiment will be described with reference to the figure. It is noted that in the figures, the same parts and functions as those described in the first embodiment are denoted with the same reference numerals, and a duplicated description will not be repeated.

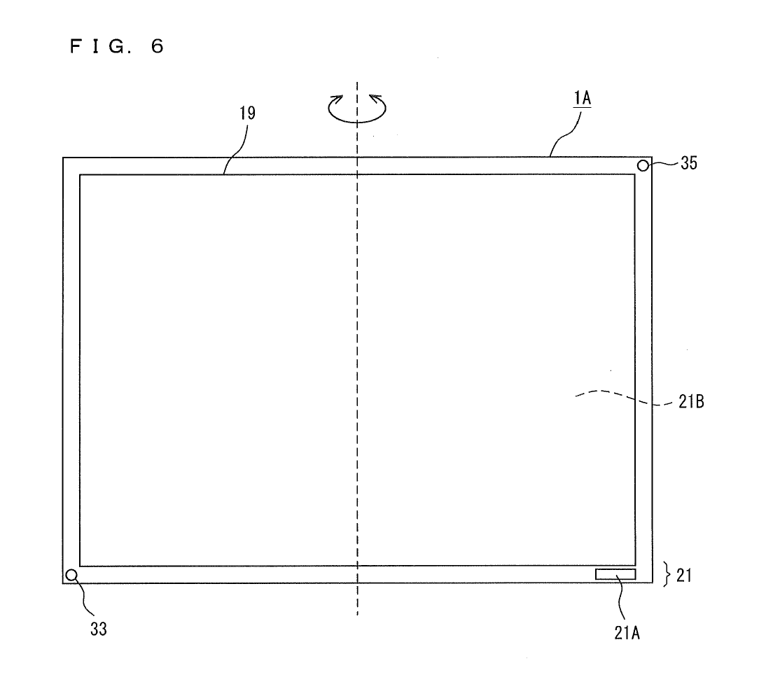

FIG. 6 is a plan view of the electronic paper in the second embodiment of the present invention. Referring to FIG. 6, electronic paper 1A in the second embodiment includes a display portion 19 on a top surface thereof, an operation portion 21 including a touch panel 21B arranged to be superimposed in the same region as display portion 19, and a power key 21A, a first light sensor 33, and a second light sensor 35. Electronic paper 1A can change its shape into the same-direction shape as shown in FIG. 6 and into the opposite-direction shape in which the display surface is folded down the center line of electronic paper 1A shown by the dotted line in FIG. 6 such that two surfaces divided by the center line face in opposite directions. It is noted that the dotted line in the figure is given for the sake of illustration and actually does not exist. In the following, the region on the left side of the dotted line in FIG. 6 of the display surface of electronic paper 1A will be referred to as a first display surface, and the region on the right side will be referred to as a second display surface. Electronic paper 1A can change its shape into the same-direction shape in which the first display surface and the second display surface of display portion 19 face in the same direction and into the opposite-direction shape in which the first display surface and the second display surface face in opposite directions.

First light sensor 33 and second light sensor 35 are arranged at a predetermined distance away from each other in the vertical and horizontal directions of electronic paper 1A. More specifically, first light sensor 33 and second light sensor 35 are arranged on the same top surface as display portion 19 of electronic paper 1A is arranged, and are arranged on an extended line of the diagonal of display portion 19 on the outside of display portion 19. Therefore, when a copier scans electronic paper 1A face down on the copier in the same-direction shape, first light sensor 33 and second light sensor 35 are not scanned simultaneously but scanned at different times.

In the case where electronic paper 1A is in the opposite-direction shape, first light sensor 33 is arranged in the same direction as the first display surface of electronic paper 1A, and second light sensor 35 is arranged in the same direction as the second display surface of electronic paper 1A.

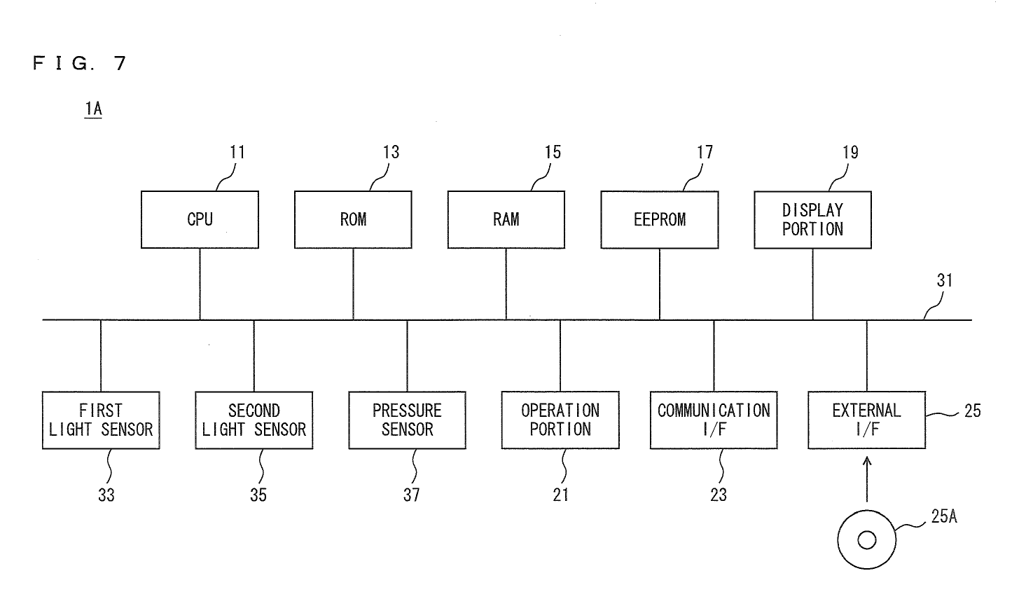

FIG. 7 is a block diagram showing an exemplary hardware configuration of the electronic paper in the second embodiment. FIG. 7 differs from the block diagram in FIG. 2 in that it includes first light sensor 33 and second light sensor 35 in place of flat light sensor 27 and includes a pressure sensor 37.

First light sensor 33 and second light sensor 35 each output a detection signal to CPU 11 while detecting light at a prescribed intensity or higher, and output none while not detecting light at a prescribed intensity or higher. Since first light sensor 33 and second light sensor 35 are arranged at a predetermined distance away from each other in the vertical and horizontal directions of electronic paper 1A, when electronic paper 1A is placed in the same-direction shape on a copier and scanned, first light sensor 33 and second light sensor 35 output detection signals to CPU 11 at different times.

Pressure sensor 37 is arranged on the back surface of electronic paper 1A, for example, on the back side of first light sensor 33. When electronic paper 1A is in the opposite-direction shape, pressure sensor 37 is pressed by a protrusion provided on the opposing surface to turn on, and when electronic paper 1A is not in the opposite-direction shape, pressure sensor 37, released from the pressing from the opposing surface, turns off. Pressure sensor 37 outputs an ON or OFF signal to CPU 11.

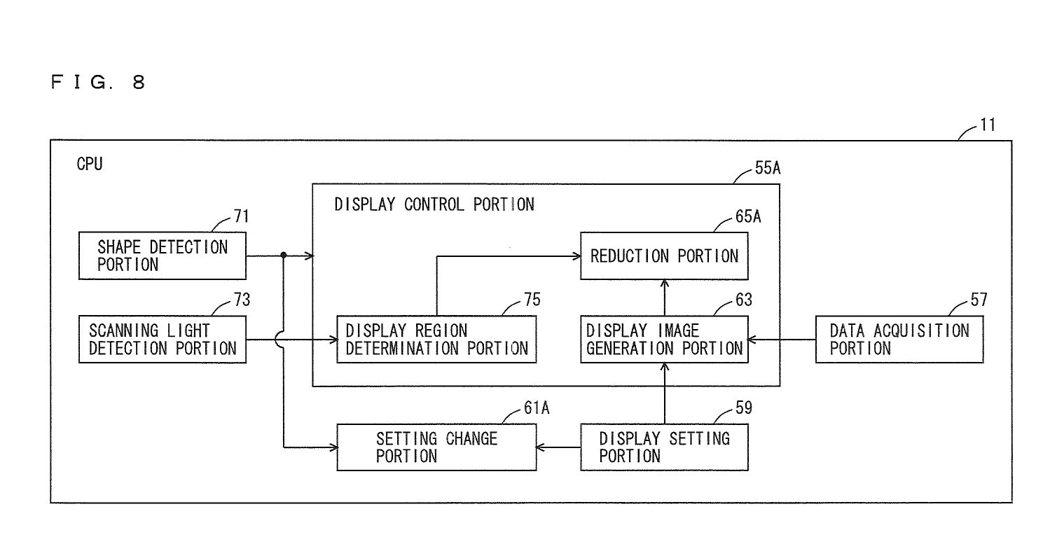

FIG. 8 is a functional block diagram showing an example of functions of the CPU of the electronic paper in the second embodiment. The functions of CPU 11 shown in FIG. 8 are formed in CPU 11 when CPU 11 executes a display control program stored in ROM 13, EEPROM 17, or CD-ROM 25A.

Referring to FIG. 8, CPU 11 includes a shape detection portion 71 for detecting the shape of electronic paper 1A, a scanning light detection portion 73 for detecting scanning light, a display control portion 55A for controlling display of electronic paper 1A, a data acquisition portion 57, a display setting portion 59, and a setting change portion 61A. Data acquisition portion 57 and display setting portion 59 are the same functions as those shown in FIG. 3, and a description thereof will not be repeated here.

Shape detection portion 71 monitors output of pressure sensor 37, detects the opposite-direction shape when pressure sensor 37 outputs ON, and detects the same-direction shape when pressure sensor 37 outputs OFF. Shape detection portion 71 outputs the detected shape of electronic paper 1A to display control portion 55A.

Scanning light detection portion 73 monitors outputs of first light sensor 33 and second light sensor 35, outputs a first state signal to display control portion 55A when detecting that first light sensor 33 outputs a detection signal, and outputs a second state signal to display control portion 55A when detecting that second light sensor 35 outputs a detection signal.

Setting change portion 61A receives the shape of electronic paper 1A from shape detection portion 71. When the layout manner is set to “2-in-1” or “booklet” in display setting portion 59 and when the shape of electronic paper 1A is the opposite-direction shape, setting change portion 61A changes the layout manner to “normal layout.” When the setting of layout manner is changed by setting change portion 61, display setting portion 59 outputs the changed setting information to display control portion 55.

Display control portion 55 includes a display image generation portion 63, a reduction portion 65A, and a display region determination portion 75. Display image generation portion 63 is the same function as that shown in FIG. 3.

Display region determination portion 75 receives the shape of electronic paper 1A from shape detection portion 71 and receives one of the first state signal and the second state signal from scanning light detection portion 73. When the opposite-direction shape is input from shape detection portion 71 and the first state signal is input from scanning light detection portion 73, display region determination portion 75 determines the first display surface as a display region for displaying an image. When the opposite-direction shape is input from shape detection portion 71 and the second state signal is input from scanning light detection portion 73, display region determination portion 75 determines the second display surface as a display region for displaying an image. When the same-direction shape is input from shape detection portion 71, display region determination portion 75 determines the first display surface and the second display surface as a display region for displaying an image. Display region determination portion 75 outputs the determined display region to reduction portion 65A.

Reduction portion 65A receives a display image from display image generation portion 63 and receives a display region from display region determination portion 75. When one of the first display surface and the second display surface is input as a display region from display region determination portion 75, reduction portion 65A sets a reduction ratio to 50%. When the first display surface and second display surface is input as a display region from display region determination portion 75, reduction portion 65A sets a reduction ratio to 100%. Reduction portion 65A generates a reduced image by reducing the display image input from display image generation portion 63 at the determined reduction ratio. When the determined reduction ratio is 100%, the display image is not reduced.

When the opposite-direction shape is input from shape detection portion 71 and the first state signal is input from scanning light detection portion 73, display control portion 55 displays the reduced image generated by reduction portion 65A on the first display surface of electronic paper 1A. When the opposite-direction shape is input from shape detection portion 71 and the second state signal is input from scanning light detection portion 73, display control portion 55 displays the reduced image generated by reduction portion 65A on the second display surface of electronic paper 1A. When the same-direction shape is input from shape detection portion 71, display control portion 55 displays the display image generated by display image generation portion 63 on the display surface of electronic paper 1A. When the reduced image is displayed on the first display surface or the second display surface, the reduced image is displayed in a predetermined orientation on each of the first display surface and the second display surface.

When the same-direction shape is input from shape detection portion 71, display control portion 55 displays the display image generated by display image generation portion 63 on the display surface of electronic paper 1A.

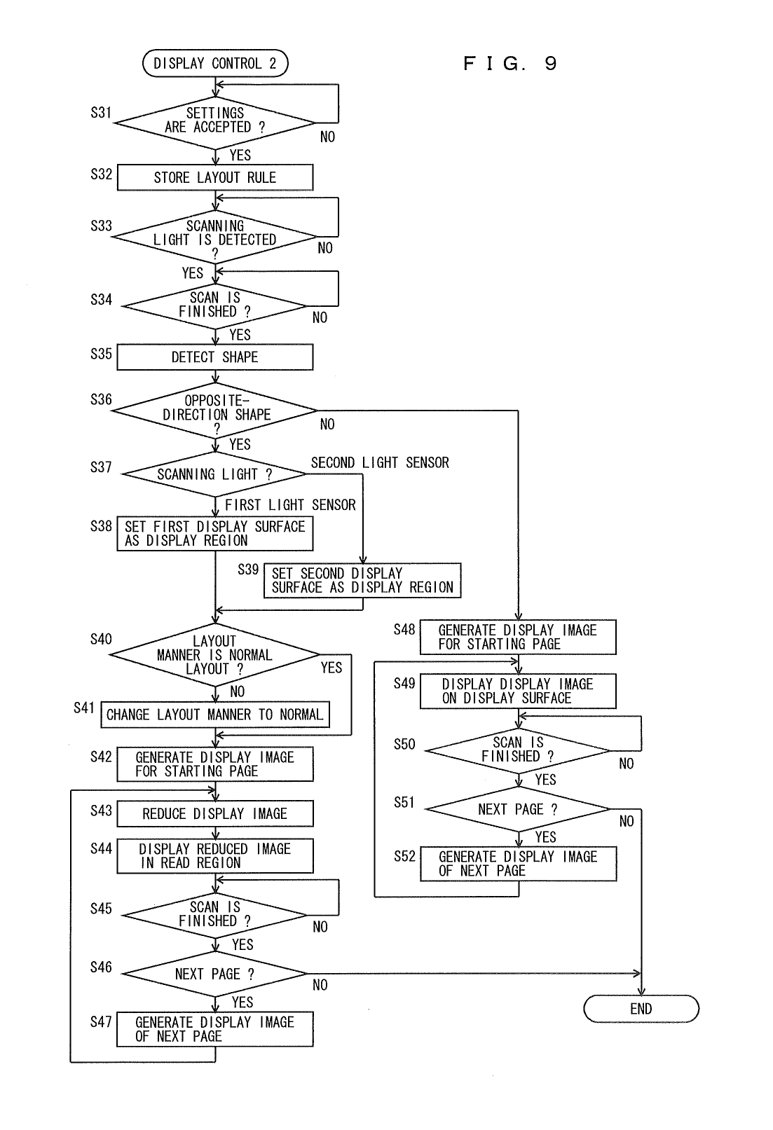

FIG. 9 is a flowchart showing an exemplary flow of a display control process in the second embodiment. The display control process is a process executed by CPU 11 when CPU 11 executes a display control program stored in EEPROM 17. Referring to FIG. 9, step S31 and step S32 are the same as step S01 and step S02, respectively, in FIG. 5. Therefore, a description thereof will not be repeated here. In step S33, it is determined whether scanning light is detected. Scanning light is detected if one of first light sensor 33 and second light sensor 35 detects light at a prescribed intensity. The process waits until scanning light is detected (NO in step S33). If one of first light sensor 33 and second light sensor 35 detects light at a prescribed intensity (YES in step S33), it is determined that pre-scan by a copier starts, and the process then proceeds to step S34. In the next step S34, it is determined whether the scan is finished. When a prescribed time has passed since one of first light sensor 33 and second light sensor 35 detected light at a prescribed intensity, it is determined that the scan by pre-scan is finished. The prescribed time is a predetermined value. The process waits until the end of scan is detected (NO in step S34). If the end of pre-scan is detected (YES in step S34), the process proceeds to step S35.

In step S35, the shape of electronic paper 1A is detected based on output of pressure sensor 37. If output of pressure sensor 37 is ON, the opposite-direction shape is detected. If it is OFF, the same-direction shape is detected. Then, it is determined whether the detected shape is the opposite-direction shape (step S36). If electronic paper 1A is in the opposite-direction shape, the process proceeds to step S37. If electronic paper 1A is in the same-direction shape, the process proceeds to step S48. The processing from step S48 to step S52 is the same as the processing in step S20 to step S24 in FIG. 5. Therefore, a description thereof will not be repeated here.

In step S37, the process branches depending on which of first light sensor 33 and second light sensor 35 detects scanning light in step S33. If light at a predetermined intensity is detected by first light sensor 33, the process proceeds to step S38. If light at a prescribed intensity is detected by second light sensor 35, the process proceeds to step S39. In step S38, the first display surface is set as a display region, and the process proceeds to step S40. On the other hand, in step S39, the second display surface is set as a display region, and the process proceeds to step S40.

In step S40, it is determined whether the layout manner is normal layout. If the layout manner of the layout rule temporarily stored in RAM 15 in step S32 is not set to normal layout, the process proceeds to step S41. If it is set to normal layout, the process skips step S41 and proceeds to step S42. In step S41, the layout manner is changed to normal layout, and the process proceeds to step S42.

In step S42, an image for the starting page is generated. If the layout manner is changed to normal layout in step S41, an image for the starting page is generated as a display image by arranging images of a plurality of pages included in the display data read out in step S31, according to the changed layout rule. If the layout manner is not changed to normal layout in step S41, an image for the starting page is generated as a display image by arranging images of a plurality of pages included in the display data read out in step S31, according to the layout rule stored in step S32.

In the next step S43, the display image is reduced at a reduction ratio of 50%. Then, the reduced image generated by reducing the display image in step S43 is displayed in the display region of electronic paper 1A (step S44). If the first display surface is set as a display region in step S38, the reduced image is displayed on the first display surface. If the second display surface is set as a display region in step S39, the reduced image is displayed on the second display surface.

In the next step S45, it is determined whether the scan is finished. When a prescribed time has passed since one of first light sensor 33 and second light sensor 35 detected light at a prescribed intensity, it is determined that the scan by pre-scan is finished. The prescribed time is a predetermined value. The process waits until the end of scan is detected (NO in step S45).

If the end of pre-scan is detected (YES in step S45), the process proceeds to step S46. The reduced image displayed on electronic paper 1A does not switch until the copier has finished a single scan, so that the time for the copier to read off the reduced image appearing on electronic paper 1A is ensured.

In step S46, it is determined whether there exists a page that has not been displayed as a display image among the pages included in the display data. If such a page exists, the process proceeds to step S47. If not, the process ends. In step S47, a display image of the next page is generated in a similar manner as the generation of a display image for the starting page in step S42. The process then returns to step S43.

Electronic paper 1A in the second embodiment can change its shape into the same-direction shape in which the first display surface and the second display surface face in the same direction and into the opposite-direction shape in which the first display surface and the second display surface face in opposite directions. When the detected shape of electronic paper 1A is the opposite-direction shape, a reduced image generated by reducing a display image is displayed on one of the first display surface and the second display surface from which the scanning light of the copier is detected. Therefore, even when the display surface is folded, a reduced image generated by reducing a display image is displayed on the side read by the copier. As a result, the images of all the pages included in the display data can be read by the copier.

In the foregoing embodiments, electronic paper 1, 1A has been described as an example of the flat display device. However, it is needless to say that the present invention can be understood as a display control method for executing the display control process shown in FIG. 5 or FIG. 9 in electronic paper 1, 1A or a display control program for causing CPU 11 of electronic paper 1, 1A to execute the display control method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A flat display device that can be placed on an image reading apparatus, comprising:
a display surface to display an image;
a light detection portion provided on said display surface to detect light;
a read region detection portion to, if scanning light emitted by said image reading apparatus is detected by said light detection portion, determine a read region in said display surface based on said detected scanning light; and
a display control portion to display an image in said determined read region in said display surface.

2. The flat display device according to claim 1, wherein said display control portion includes a first display orientation determination portion to determine an orientation in which said image is displayed in said determined read region in said display surface, based on an aspect ratio of said determined read region and an aspect ratio of said image.

3. The flat display device according to claim 1, further comprising a main scanning direction detection portion to detect a scanning direction with respect to said display surface based on said detected scanning light,
wherein said display control portion further includes a second display orientation determination portion to determine an orientation in which said image is displayed in said read region, based on said detected scanning direction.

4. The flat display device according to claim 1, wherein said display control portion further includes a reduction portion to reduce an image based on a size of said determined read region in said display surface.

5. The flat display device according to claim 1, further comprising a setting change portion to change setting such that an image of one page is successively displayed in a page number order, when setting is such that a composite image including images of a plurality of pages arranged side by side is successively displayed and if the determined read region is smaller than said display surface.

6. The flat display device according to claim 1, wherein said flat display device is electronic paper.

7. The flat display device according to claim 1, wherein said display surface includes a first display surface and a second display surface and can change its shape into a same-direction shape in which said first display surface and said second display surface face in a same direction, and into an opposite-direction shape.

8. A flat display device that can be placed on an image reading apparatus, comprising:
a display surface including a first display surface and a second display surface to display an image,
wherein said display surface can change its shape into a same-direction shape in which said first display surface and said second display surface face in a same direction and into an opposite-direction shape in which said first display surface and said second display surface face in opposite directions;
a shape detection portion to detect a shape of said display surface;
a light scanning detection portion to detect scanning light emitted by said image reading apparatus; and
a display control portion to display an image on one of said first display surface and said second display surface from which said scanning light is detected, when said scanning light is detected in a state in which said opposite-direction shape is detected by said shape detection portion.

9. The flat display device according to claim 8, wherein said flat display device is electronic paper.

10. A display control method executed in a flat display device that can be placed on an image reading apparatus,
said flat display device including
a display surface to display an image and
a light detection portion provided on said display surface to detect light, said display control method comprising the steps of;
if scanning light emitted by said image reading apparatus is detected by said light detection portion, determining a read region in said display surface based on said detected scanning light; and
displaying an image in said determined read region in said display surface.

11. The display control method according to claim 10, wherein said step of displaying an image includes the step of determining an orientation in which said image is displayed in said determined read region in said display surface, based on an aspect ratio of said determined read region and an aspect ratio of said image.

12. The display control method according to claim 10, further comprising the step of detecting a scanning direction with respect to said display surface based on said detected scanning light,
wherein said step of displaying an image includes the step of determining an orientation in which said image is displayed in said read region, based on said detected scanning direction.

13. The display control method according to claim 10, wherein said step of displaying an image further includes the step of reducing an image based on a size of said read region in said display surface if setting is such that an image is displayed on the entire said display surface.

14. The display control method according to claim 10, further comprising the step of changing setting such that an image of one page is successively displayed in a page number order, when images of a plurality of pages are set such that a composite image in which an image of an odd page number and an image of an even page number are arranged side by side is successively displayed, and if said determined read region is smaller than said display surface.

15. A non-transitory computer-readable recording medium encoded with a display control program performed by a computer, said computer being configured to control a flat display device that can be placed on an image reading apparatus,
said flat display device including
a display surface to display an image and
a light detection portion provided on said display surface to detect light,
said display control program causing said computer to execute processing comprising the steps of:
if scanning light emitted by said image reading apparatus is detected by said light detection portion, determining a read region in said display surface based on said detected scanning light; and
displaying an image in said determined read region in said display surface.

16. The computer-readable recording medium encoded with a display control program according to claim 15, wherein said step of displaying an image includes the step of determining an orientation in which said image is displayed in said determined read region in said display surface, based on an aspect ratio of said determined read region and an aspect ratio of said image.

17. The computer-readable recording medium encoded with a display control program according to claim 15, said display control program further causing said computer to execute the step of detecting a scanning direction with respect to said display surface based on said detected scanning light,
wherein said step of displaying an image includes the step of determining an orientation in which said image is displayed in said read region, based on said detected scanning direction.

18. The computer-readable recording medium encoded with a display control program according to claim 15, wherein said step of displaying an image further includes the step of reducing an image based on a size of said read region in said display surface if setting is such that an image is displayed on the entire said display surface.

19. The computer-readable recording medium encoded with a display control program according to claim 15, said display control program further causing said computer to execute the step of changing setting such that an image of one page is successively displayed in a page number order, when images of a plurality of pages are set such that a composite image in which an image of an odd page number and an image of an even page number are arranged side by side is successively displayed, and if said determined read region is smaller than said display surface.
